(19) United States
(12) Patent Application Publication
(10) Pub. No.: US 2024/0116778 A1
(43) Pub. Date: Apr. 11, 2024

(54) METHOD AND APPARATUS FOR FLASH LAMP TREATMENT OF LIQUID STREAMS

(71) Applicant: KING ABDULLAH UNIVERSITY OF SCIENCE AND TECHNOLOGY, Thuwal (SA)

(72) Inventors: Thomas D. ANTHOPOULOS, Thuwal (SA); Luca FORTUNATO, Thuwal (SA); Emre YARALI, Thuwal (SA)

(21) Appl. No.: 18/286,244

(22) PCT Filed: Apr. 11, 2022
(86) PCT No.: PCT/IB2022/053390

§ 371 Date: Oct. 10, 2023

Related U.S. Application Data
(60) Provisional application No. 63/174,371, filed on Apr. 13, 2021.

(51) Int. Cl. C02F 1/32

(52) U.S. Cl. CPC C02F 1/325; C02F 2101/30

(57) ABSTRACT

An active flash-light treatment system is configured to degrade organic pollutants in a liquid stream. The system includes a reactor configured to receive the liquid stream, a light source configured to generate an emitted light having a first wavelength range, an upstream sensor configured to measure a characteristic of the liquid stream before entering the reactor, and a controller configured to analyze the characteristic of the liquid stream and to select a wavelength-conversion material for the reactor, based on the characteristic of the liquid stream. The wavelength-conversion material is configured to absorb the emitted light and generate a converted light having a second wavelength range, different from the first wavelength range, and the converted light irradiates the liquid stream to degrade the organic pollutants.

### CROSS-REFERENCE TO RELATED APPLICATIONS

This application claims priority to U.S. Provisional Patent Application No. 63/174,371, filed on Apr. 13, 2021, entitled “METHOD AND APPARATUS FOR FLASH LAMP TREATMENT OF LIQUID STREAMS AND THIN-FILM POLYMERIC MEMBRANES,” the disclosure of which is incorporated herein by reference in its entirety.

### BACKGROUND

### Technical Field

Embodiments of the subject matter disclosed herein generally relate to a system and method for treating a liquid stream for removing various pollutants, and more particularly, to a smart flash lamp-based treatment system that quickly and continuously treats the liquid stream for removing organic micro-pollutants, and while doing this, determines the type of pollutants and adjusts the light source characteristics for more efficiently removing the determined pollutants.

### Discussion of the Background

Organic micro-pollutant (OMPs), also referred to as emerging contaminants due to their accumulation in receiving water bodies and the lack of regulations under current environmental law, involve a long list of pharmaceutical, hormones, personal care products, industrial additives, etc. The presence of OMPs on wastewater effluents, also in surface waters, and aquifers has become a rising concern due to their high persistence, ubiquitous nature, and toxic effects on the environment and human health even at concentrations in the ng-μg/L level.

Because conventional water and wastewater treatment methods and plants are unable to remove recalcitrant organic micropollutants, advanced water treatment processes have been proposed and tested in the last years. Advanced oxidation processes (AOPs) like photocatalysis, ozonation, photo-Fenton, UV/H₂O₂, ionizing radiation, non-thermal plasma, and sonolysis have been proposed for the treatment of OMPs [1, 2]. The AOPs enable the degradation of organic pollutants through the generation of highly reactive oxidation species, whereas the yield of degradation mainly depends on the pollutant chemical structure, the OMPs concentration, the water matrix, and pH. However, these areas demand more research and development, whereas the application on a large scale is limited due to the long treatment time, high capital and operating costs, and the generation of oxidation by-products.

Thus, there is a need for a new system and method that are capable of quickly and continuously removing or degrading the organic micropollutants from a liquid stream so that the process can be applied to large scale water treatment plants.

### BRIEF SUMMARY OF THE INVENTION

According to an embodiment, there is an active flash-light treatment system configured to degrade organic pollutants in a liquid stream. The system includes a reactor configured to receive the liquid stream, a light source configured to generate an emitted light having a first wavelength range, an upstream sensor configured to measure a characteristic of the liquid stream before entering the reactor, and a controller configured to analyze the characteristic of the liquid stream and to select a wavelength-conversion material for the reactor, based on the characteristic of the liquid stream. The wavelength-conversion material is configured to absorb the emitted light and generate a converted light having a second wavelength range, different from the first wavelength range. The converted light irradiates the liquid stream to degrade the organic pollutants.

According to another embodiment, there is a reactor that is part of an active flash-light treatment system configured to degrade organic pollutants in a liquid stream. The reactor includes a housing configured to house the liquid stream while the liquid stream flows through the reactor, a light source configured to generate an emitted light having a first wavelength range, wherein the light source is placed within the housing, and a removable wavelength-conversion material configured to absorb the emitted light and generate a converted light having a second wavelength range, different from the first wavelength range. The converted light irradiates the liquid stream to degrade the organic pollutants.

According to yet another embodiment, there is a method for degrading organic pollutants in a liquid stream with an active flash-light treatment system. The method includes monitoring a characteristic of the liquid stream entering a reactor with an upstream sensor, determining the characteristic with a controller, determining a type of the organic pollutant at the controller, based on the characteristic, selecting a wavelength-conversion material based on the characteristic of the liquid stream, removably placing the wavelength-conversion material onto the reactor, and emitting a light having a first wavelength range, with a light source, which is located within the reactor, to degrade the organic pollutants. The wavelength-conversion material is configured to absorb the emitted light and generate a converted light having a second wavelength range, different from the first wavelength range, and the converted light irradiates the liquid stream to degrade the organic pollutants.

According to yet another embodiment, there is an active flash-light treatment system configured to tailor a treatment of a liquid stream. The system includes an interface configured to receive from a server an initial treatment plan for a given water treatment process, a processor configured to execute the initial treatment plan within a reactor by applying a light with a light source, the emitted light having a first wavelength range, and a downstream sensor configured to measure a characteristic of the liquid stream after being treated with the emitted light in the reactor. The processor is further configured to run an algorithm on the server to generate the initial treatment plan, run the algorithm, taking into account the measured characteristic after executing the initial treatment plan, to update the initial treatment plan to reduce an amount of energy used to degrade a pollutant, and run the updated treatment plan.

### BRIEF DESCRIPTION OF THE DRAWINGS

For a more complete understanding of the present invention, reference is now made to the following descriptions taken in conjunction with the accompanying drawings, in which:

FIG. 1 is a schematic diagram of an active flash light treatment system that is configured to degrade organic pollutants;

FIG. 2 is another schematic diagram of an active flash light treatment system that is configured to degrade organic pollutants with plural reactors;

FIG. 3 schematically illustrates various parameters controlled by a controller for adjusting the flash light treatment in the reactor;

FIG. 4 schematically illustrates how the controller uses artificial intelligence to adjust the parameters of a flash lamp located within the reactor;

FIGS. 5A and 5B show one reactor that may be used with the active flash light treatment system;

FIG. 6 illustrates the light spectrum emitted by a light source of the active flash light treatment system;

FIG. 7 illustrates a wavelength-conversion material that is used with the light source in the reactor to change the wavelength of the emitted light;

FIG. 8 illustrates a wavelength-conversion material that is placed around the light source in the reactor to change the wavelength of the emitted light;

FIG. 9 illustrates the reactor of the active flash light treatment system having plural light sources;

FIG. 10 illustrates another arrangement of the plural light sources within the reactor;

FIG. 11 illustrates the addition of static mixers inside the reactor for mixing the liquid stream and/or further reflecting the emitted light;

FIG. 12 illustrates still another reactor with an active stirrer for the active flash light treatment system;

FIGS. 13A and 13B illustrate variations of the reactor of the active flash light treatment system and the placement of the plural light sources inside the reactor;

FIG. 14 illustrates the removal rate of various organic pollutants obtained with the active flash light treatment system after a single pulse treatment;

FIG. 15 illustrates the effect of the number of pulses of light discharged into the reactor on the organic pollutants;

FIG. 16 illustrates the effect of the energy amount of the light discharged into the reactor on the organic pollutants;

FIG. 17 illustrates the effect of the irradiation time of the light discharged into the reactor on the organic pollutants;

FIG. 18 illustrates the time necessary for reducing 90% of various organic pollutants with the active flash light treatment system;

FIG. 19 is a flow chart of a method for using the active flash light treatment system for degrading organic pollutants in a liquid stream;

FIG. 20 illustrates the effect of the addition of an oxidant to the active flash light treatment system;

FIG. 21 illustrates the absorbance of a red dye when exposed to the active flash light treatment system;

FIG. 22 illustrates the removal percentage of a blue dye when irradiated within the active flash light treatment system; and

FIG. 23 illustrates the removal percentage of the blue dye when an oxidant is added to the photolysis process provided by the active flash light treatment system.

### DETAILED DESCRIPTION OF THE INVENTION

The following description of the embodiments refers to the accompanying drawings. The same reference numbers in different drawings identify the same or similar elements. The following detailed description does not limit the invention. Instead, the scope of the invention is defined by the appended claims.

Reference throughout the specification to “one embodiment” or “an embodiment” means that a particular feature, structure or characteristic described in connection with an embodiment is included in at least one embodiment of the subject matter disclosed. Thus, the appearance of the phrases “in one embodiment” or “in an embodiment” in various places throughout the specification is not necessarily referring to the same embodiment. Further, the particular features, structures or characteristics may be combined in any suitable manner in one or more embodiments.

According to an embodiment, a novel water treatment reactor has one or more sensors for determining one or more properties of the liquid stream flowing through the reactor, and also has a controller for determining what flash-light treatment to apply to the liquid stream, based on the measured one or more properties, for most efficiently and rapidly removing the OMPs present in the stream. The reactor's light source can be adjusted in real time to emit the most effective light spectrum for the type of OMP detected. This smart system is not only fast and can treat a liquid stream, but can adjust itself to the detected pollutants to apply the most efficient light spectrum.

Recently, photonic-based processes, such as laser and continuous UV treatments, have been exploited for applications in the electronic industry for (post) thermal treatments and photochemical decomposition reactions [3-6]. Among these techniques, flash-light treatment (FLT) has been attracting increasing attention due to its low-cost, scalability and easy processing. During processing with FLT, a high-intensity light generated by a flash lamp is directed towards a target material(s) in the form of short pulses with duration ranging from micro to milliseconds. Depending on the absorption characteristics of the targeted materials or samples, the FLT leads to a sudden rise of its temperature and/or photochemical reactions [7]. The technique has been already employed in several research fields for metal ink sintering [8], thin-film transistor [9, 10], and solar cell fabrication [6].

However, a problem with the existing FLT systems is that they are not capable to react to the treated material, i.e., their light spectrum is fixed and it cannot be changed no matter how the target material is changing. In addition, the existing FLT systems are not configured to measure any characteristic or property of the target material. This is so because the existing FLT systems are used in static environments, i.e., situations or cases in which the target material is the same, all the time. Therefore, the existing FLT systems are passive systems. The inventors have designed an active (i.e., smart) FLT system that is capable of actively (e.g., in real time) determining one or more characteristics of the pollutants present in the treated liquid, and also actively changing the emitted light spectrum of the FLT system for addressing the detected pollutant. The inventors have also studied the photodegradation kinetics of 11 emerging OMPs in the liquid stream with such a novel active FLT system, and these results are discussed later. According to the embodiments discussed herein, this new system proves the potential of the active FLT system as post-treatment technique for the degradation of emerging organic contaminants present in polluted water.

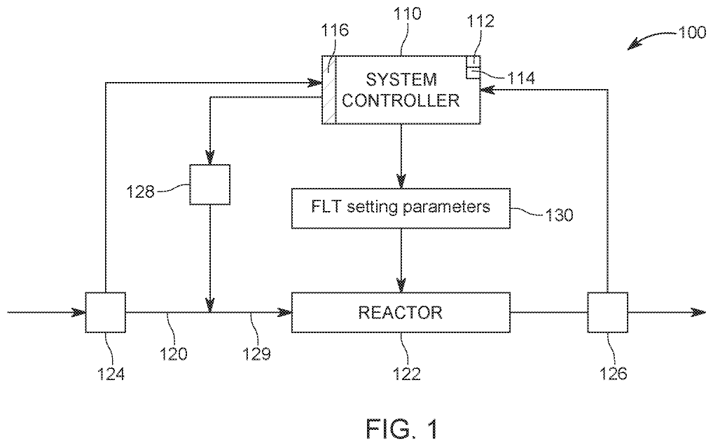

More specifically, as illustrated in FIG. 1, an active FLT system 100 includes a controller 110 that constitutes the brain of the system. The controller 110 includes at least a processor 112, a memory 114, and a communication interface 116. The communication interface 116 is configured to communicate in a wired or wireless manner with one or more other elements of the system 100, e.g., sensors, databases, light source, plant operator, etc. The memory 114 may store various possible scenarios related to the liquid stream 120 that passes through a reactor 122. For example, the memory may store a table that associates various values of a characteristic of the liquid stream 120 to a light spectrum to be applied by a light source (not shown) associated with the reactor. The characteristic may be the type of the pollutant, a concentration of the pollutant, turbidity, flowrate, temperature, pH, electrical conductivity, absorption spectrum, etc. The values of the characteristic are determined by an upstream (or first) inline sensor 124, which is placed upstream of the reactor 122 as shown in the figure. A downstream (or second) inline sensor 126 may also be placed downstream of the reactor 122 for measuring the same parameter (or another one) after the FLT treatment, to evaluate the efficiency of the treatment and whether other or further treatments are required. In one implementation, depending on the reading of the first sensor 124, the controller 110 may determine that the addition of a chemical, in addition to the FLT treatment, may be beneficial. For this case, the controller 110 may instruct a storage tank 128 to release a given chemical (for example, reactive oxygen species H₂O₂) into the piping 129 that feeds the liquid stream 120 to the reactor 122. While FIG. 1 shows the storage tank 128 releasing its chemical upstream the reactor 122, in another embodiment, it is possible to release the chemical into or downstream of the reactor.

FIG. 1 also shows a database 130 that stores various parameters of the reactor 122, for example, frequency of light pulses to be emitted inside the reactor by the light source, intensity of each light pulse, spectrum of the light pulse, duration of the light pulse, oxidant dosing, lamp triggering, emitted light intensity, hydraulic retention time, etc., which are discussed later. These parameters may automatically be modified by the controller 110 based on the input from the sensors. However, as also discussed later, there are some features and/or characteristics of the reactor that need to be manually adjusted. For these features, the controller 110 determines what their value should be, and the operator of the reactor has to manually replace one or more parts of the reactor to achieve the desired features. One skilled in the art would also know how to automatize this action so that no direct human interaction is needed.

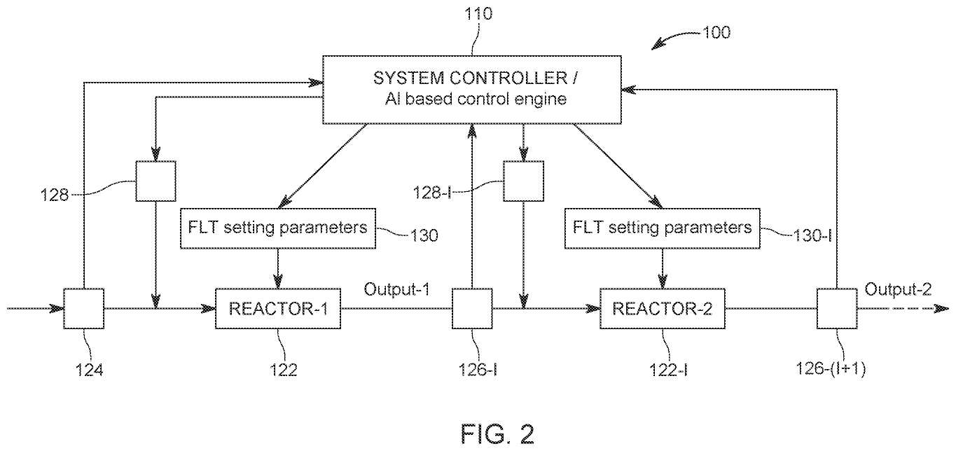

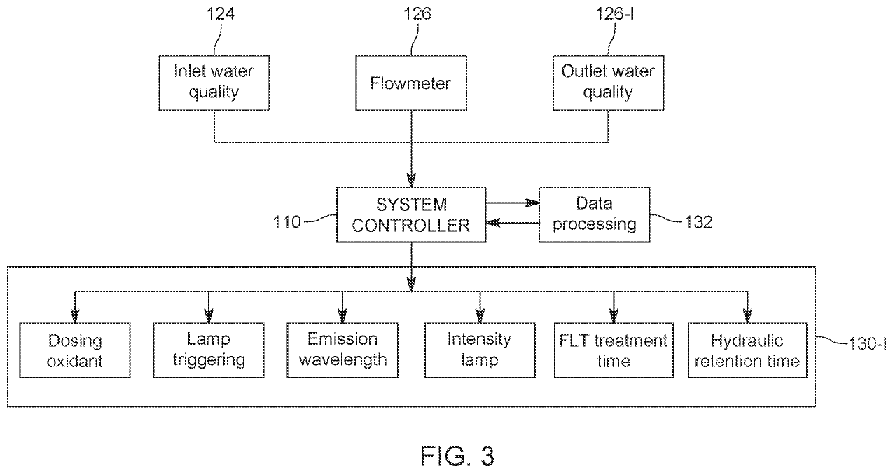

While FIG. 1 shows the controller 110 controlling a single reactor 122, in one embodiment, as illustrated in FIG. 2, it is possible to have plural reactors 122-I (where I is a natural number equal to or larger than one) connected in series, so that the liquid stream 120 passes from one reactor into the next one, and thus successive steps of the FLT treatment may be applied. For this case, the controller 110 is configured to control each reactor. Having the reactors 122-I connected in series helps to improve the effectiveness and throughput and/or add functionalities (or flexibility) to the system. In this case, each reactor may have associated upstream and downstream sensors 124 and 126-1, and also associated storage tanks 128-I for dispensing a corresponding chemical. Each reactor 122-1 may also have an associated FLT setting parameters database 130-I so that each reactor can be adjusted independent and autonomous of the other reactors (see configuration in FIG. 3). For example, different reactors with different light-emitting characteristics can be connected in series in order to better remove the micropollutants based on the data from the inline monitoring system in tandem with the controller 110. The system controller 110 can run an Al algorithm, which may be stored in a data processing unit 132 (see FIG. 3), for deciding what light spectrum to be emitted by which reactor. On the other hand, connecting many reactors/systems in parallel is also possible to increase the throughput.

In one embodiment, it is possible to configure and control the plural reactors 1221 to emit different spectra/wavelengths. Such system could be used to target different micropollutants in a series manner, by the different reactors. The inline monitoring method allows customization of the treatment process depending on the type and concentration of the different pollutants in the water. Al algorithms 132 on the other hand can be used to further boost the speed and efficiency (treatment time, energy etc.) of the reactor system. Such modular system can provide the flexibility in cases where the nature/chemistry of the micropollutants is not precisely known. The Al controller 110 may then be used to train the system for optimal treatment process. The Al approach may also involve the use of a library of data on all known micropollutants as to better optimize and adjust the treatment time.

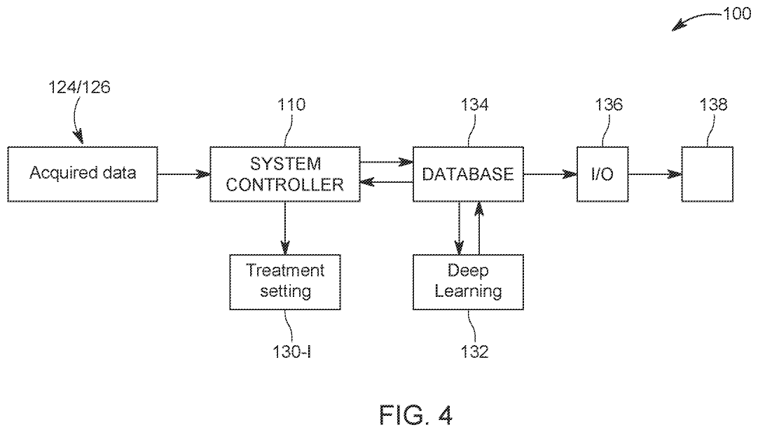

The algorithm 132 (e.g., deep learning) may be connected to a database 134, as illustrated in FIG. 4, and this database is configured to provide important information, such as physical characteristics (e.g., absorption spectra of the pollutant), and all the kinetic information related to the degradation of a given compounds/wastewater, including the kinetic of degradation and the time and condition of treatment required to achieve the desired final water quality. Such information may be obtained either from existing literature/data bases, or via training of the treatment system. The database information may be constantly updated through a feedback loop as illustrated in FIG. 4. Further, as also shown in the figure, the database 134 may be connected to an input/output interface 136 that is configured to communicate in real time with a web portal or server 138. In this way, the database 134 has live access to information about any pollutant that is detected by the sensors 124. Thus, according to this embodiment, the system 100 is capable of determining the presence of any pollutant, seeking information about that pollutant either in the stored information in the database 134, or on the Internet through the web portal 138, acquiring the parameters that describe that pollutant, and then, based on all this information, making a decision, in the controller 110, about the FLT parameters to be applied to the light source in the reactor, as they are listed in FIG. 3, under the 130-I parameters set, to efficiently degrade the pollutant.

More specifically, in one embodiment, the active flash-light treatment system 100 is configured to tailor a treatment of a liquid stream. To achieve this, the system 100 uses the interface 136 to receive from a server 138 an initial treatment plan for a given water treatment process. The processor 112 is configured to execute the initial treatment plan within the reactor 122 by applying the light 512 with the light source 510, the emitted light 512 having a first wavelength range. The downstream sensor 126 is configured to measure a characteristic of the liquid stream 120 after being treated with the emitted light 512 in the reactor 122. The processor 112 is further configured to run the algorithm 132 on the server 138 to generate the initial treatment plan, run again the algorithm 132 for the reactor 120, taking into account the measured characteristic after executing the initial treatment plan, to update the initial treatment plan to reduce an amount of energy used to degrade a pollutant, and run again the updated treatment plan in the system 100.

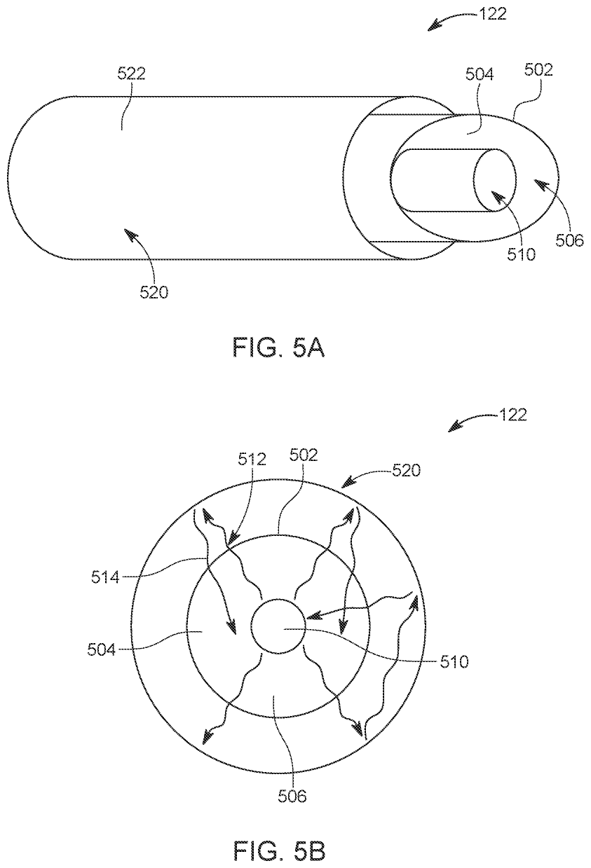

A structure of the reactor 122 is now discussed with regard to FIGS. 5A and 5B. The reactor 122 has a housing 502 made of a metal or plastic or glass or quartz or a polymeric material. In one application, the housing 502 is made to be transparent to the light emitted by a source light 510, which is placed within a chamber/bore 504 formed by the housing 502. In one application, the housing 502 has a radius in the mm to cm range, and a length in the cm to m range. The source light 510 is surrounded by a liquid 506, which forms the liquid stream 120. The liquid 506 may be water, wastewater, contaminated water, infected water, any kind of water that needs to be clean or purified. The housing 502 may be covered with a removable coating layer 520. While FIG. 5A shows the coating layer 520 being located outside the housing, in one application the coating layer is located within the housing, i.e., in direct contact with the liquid 506.

The purpose of the coating layer 520 is now discussed with regard to FIG. 5B. The light 512 emitted by the light source 510 passes through the surrounding liquid 506 and through the transparent housing 502 to arrive at the coating layer 520. The coating layer 520 is made from either a reflecting material (e.g., silver), or a wavelength-conversion material, or both. If the coating layer 520 is made of the reflecting material, the light 512 is simply reflected back as reflected light 514, to the liquid 506. For this situation, both the emitted light 512 and the reflected light 514 have the same wavelength. Note that the emitted light 512 may have a range of wavelengths. In this way, the emitted light is not passing only once through the liquid 506 for removing the various pollutants, but passes multiple times, thus increasing the efficiency of the reactor. Note that the reflected light 514 might also suffer its own reflections from the coating layer 520.

If the coating layer 520 is made of a wavelength-conversion material 522 (e.g., phosphor elements, but also perovskite-based materials), it will absorb the incoming light 512, having a first wavelength (or range of first wavelengths), and will generate a new, converted light 514, having a second wavelength (or range of second wavelengths), different from the first wavelength. The second wavelength may be larger or smaller than the first wavelength. The same is true if and the first and second wavelengths each includes a range of wavelengths. In this way, the original spectrum of the emitted light 512 (for example, visible light spectrum) is changed (for example, to a UV spectrum) by the coating layer 520, as a function of the wavelength(s) required to effectively remove the one or more pollutants present in the liquid 506. In other words, although the emitted light 512 generated by the light source 510 has a fixed spectrum, depending on the determined pollutant, the emitted light is transformed into the converted light 514, which has a different spectrum, which is fit for degrading the pollutant. In this way, the spectrum of the light source can be changed by only changing the light-conversion material 522. If the coating layer 520 is placed on the outside of the housing 502 of the reactor, as shown in FIG. 5A, it then can be quickly changed with another coating layer, when the spectrum of the light source 510 needs to be changed, for example, when another pollutant is present and the light 512 emitted by the light source does not affect that pollutant. In this way, the system 100 shown in FIG. 1 can easily adjust its emitted light spectrum without changing the light source 510, but rather changing the wavelength-conversion material that surrounds the housing 502. In one application, the coating layer 520 may be made of a catalytic material, if the coating layer is in direct contact with the liquid 506. In another embodiment, the coating layer 520 may have different regions, each region having a different material, for example, one region having an up-converting wavelength property, another region having a down-converting wavelength property, another region having a reflective material, and/or another region having a photocatalytic material.

The wavelength-conversion material 522 may include at least one of fluorescent (and/or phosphorescent) elements or particles that enable the up-conversion or down-conversion of the outputted light source emission spectrum. Thus, it is possible to convert the optical spectrum increasing the emission of specific wavelength ranges that are more effective for the degradation of specific targeted compounds (i.e., UV-C range for water disinfection or max absorption for specific compound removal). Such schemes are anticipated to improve the overall power efficiency and/or the treatment time.

In one application, the light source 510 is a flash lamp that generates a light pulse for a short time interval, then turns off, then generates another light pulse, and so on. The FLT treatment applied by the flash lamp leads to outstanding degradation kinetics requiring very short residence (treatment) time. Therefore, the reactor could be of small size compared to other conventional tertiary liquid treatment technologies most of which require long residence time and large-size reactor. For example, in the case of a wastewater (WW) treatment plant, a small tubular reactor (continuous flow) could be employed to treat the WW plant outlet before the discharge in the receiving body.

The reactor 122 could be of different shapes and sizes and could be operated in different modes depending on the specific application or site settings. The reactor could also incorporate different FLT stages with different treatment characteristics such as light spectrum (different emitted colors) that can be generated by different flash lamps and/or by using different up-converting/down-converting components/elements. The lamp 510 could have different geometries (i.e., spiral) and can be easily customized.

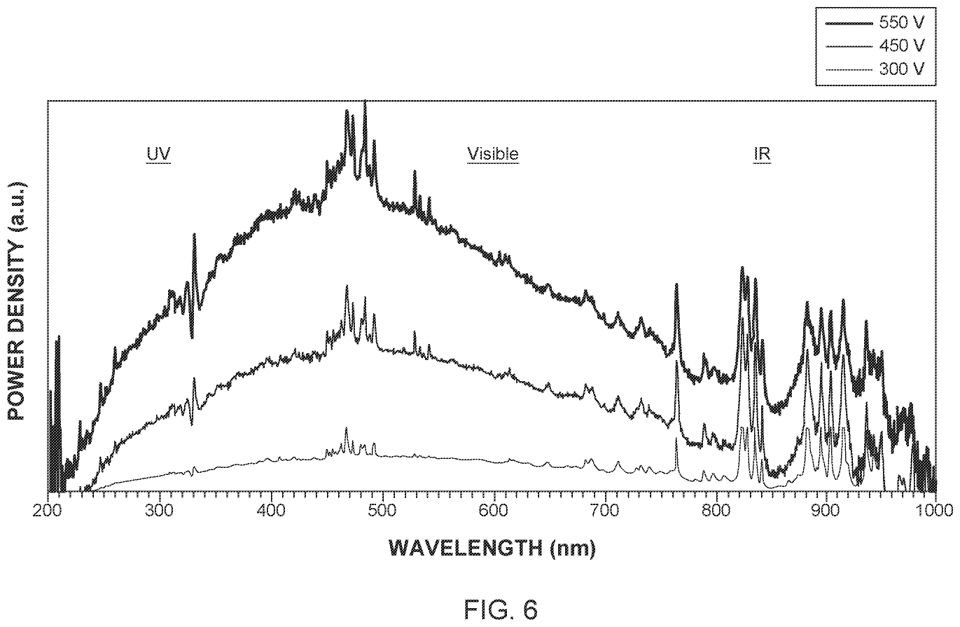

Flash lamps are arc lamps producing high-intensity wide spectrum white light in the form of short pulses. Different from continuous UV and incandescent lamps, flash lamps emit a full spectrum with high intensity in shorter times. Typical flash lamps ionize a gas (such as xenon, krypton, argon, etc.), which is filled inside a quartz tube. The flash lamp may further include a reflector, battery and controlling power unit. Under high voltage between electrodes, the gas inside the quartz tube ionizes and produces the broad-spectrum light, as shown in FIG. 6. However, dominant wavelengths range inside the visible light depends on the current density, gas pressure and type of gas used to fabricate the flash lamp. Between these parameters, the current density inside the plasma mainly determines the final emitted spectra as this parameter is dominant when compared to the gas type and gas filling pressure. For example, xenon flash lamps contain many spectral lines changing from UV to IR regions.

However, narrow to broad spectral emission transition can be controlled via the current density supplied to the gas. While xenon flash lamps emit long wavelengths of the spectrum (820, 900 and 1000 nm at IR portion) at lower current densities, the case is not the same for high current densities, which produces a continuum spectrum with a peak emission at shorter wavelengths. Even with higher current densities, the central portion of light can be shifted to the UV portion of the spectrum.

Apart from the current density effect, also the type of filling gas determines the spectral line emission. For example, while Krypton has strong emission lines at 760 and 810 nm, these values are changing to 670, 710, 760 and 860 nm for the Ar gas. Even though flash lamps produce a broad spectrum of light as shown in FIG. 6, a particular portion of the spectrum can be obtained using a specific filter design. For examples, for the biological application, high intensity of the UV region can be demanded and using a light filter absorbing visible and IR region can be a solution to acquire the maximum utility. With the increasing popularity and technological knowledge, flash lamps emitting in different spectra and having various shapes can be easily adapted to special uses. Considering the containment of dissimilar pollutants and microorganisms and their decomposition with different wavelengths, flash lamps with broad spectrum and short time processing ability are an appropriate solution to water purification.

With regard to the sensors 124/126, they can be optical or other type of sensors. The sensors enable measuring several parameters of the water entering the reactor, including the flow-rate and its optical and/or electronic properties, among other. For example, the use of an optical sensor in combination with a suitable light source, could enable monitoring (via spectroscopic techniques) of the concentration of pollutants and turbidity. Based on the sensor's reading, the light source step could be adjusted in order to optimize the water treatment parameters and hence the treatment efficiency by creating a feedback loop system as illustrated in FIGS. 1 and 2. Hence, the efficiency of the water treatment, as well as energy efficiency of the entire process, could be tailored and optimized automatically using the sensor feedback loop to control the treatment parameters. Example parameters that could be adjusted include, but are not limited to, frequency of light pulses, intensity of each light pulse, color spectrum of the light pulse, duration of the light pulse, the dosage of reactive oxygen species (i.e., H₂O₂), etc.

The FLT system 100 discussed above (alone or in combination with reactive oxygen species) may be used for several liquid treatment processes: removal of emerging contaminants, textile wastewater, water disinfection (virus, bacteria and other pathogens), tastes and odour (volatile compounds), ammonia, pesticides, organic matter (e.g., Perfluoroalkyl and Polyfluoroalkyl Substances, PFAS), Iron, Manganese and Arsenic, etc.

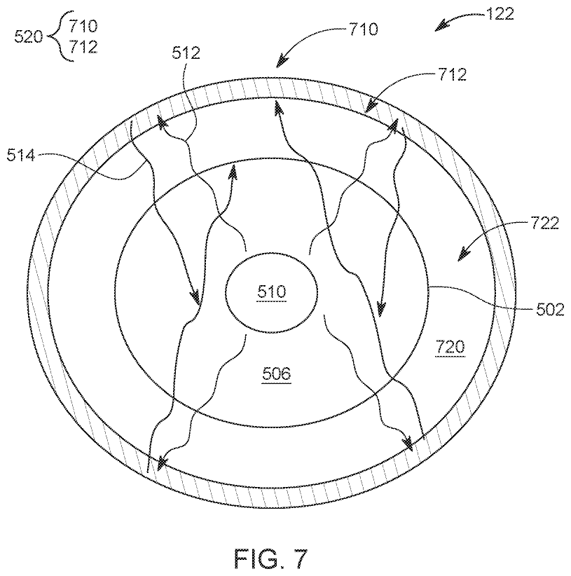

The coating layer 520 shown in FIGS. 5A and 5B was made of either a reflection material or a wavelength-conversion material or regions of both of these materials. An implementation of the coating layer 520 is shown in FIG. 7, where the reflection material 710 is the most outward layer and the wavelength-conversion material 712 is located on the inner surface of the reflection material 710, so that the conversion material 712 faces directly the housing 502. In this embodiment, there may be a layer of air 720 located in an annulus 722 defined by the outer surface of the housing 502 and the inner surface of the conversion material 712. Thus, in this embodiment, the conversion material 712 (e.g., layer of phosphor or perovskite, Cd-containing II-VI quantum dots, Cd-free III-V and I-III-VI quantum dots, but other materials may also be used) is integrated with the reflector 710, and thus, the light 512 generated by the flash lamp 510 (e.g., broad spectrum from UV to IR as shown in FIG. 6) is absorbed by the up/down-conversion material 712 and re-emitted as a new, converted light 514 at a different wavelength, with high efficiency. The re-emitted light 514 may be used to target specific parts of the absorption spectra of the micropollutant(s), hence improving the efficiency of the treatment process. For example, in a modular reactor configuration, the different modules may be equipped with different up/down-conversion materials 712 and each module is responsible for treating different molecules/products. This flexibility combined with Al optimized treatment algorithms may be very useful in this field. Overall, the use of such up/down conversion materials help utilize more of the outputted energy while in some cases may help to further accelerate the degradation of the micropollutants.

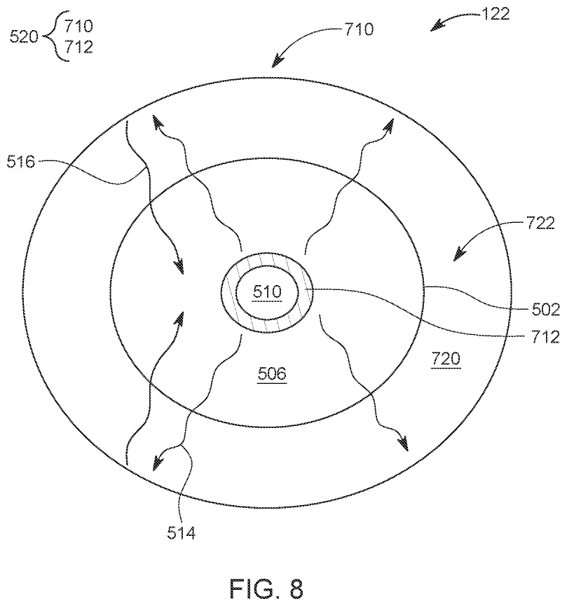

In yet another embodiment, as illustrated in FIG. 8, it is possible to place the up/down wavelength-conversion material 712 between the light source 510 and the liquid 506, i.e., the conversion material 712 is placed directly around the light source 510. This means that the light 512 emitted by the light source 510 does not travel at all through the liquid 506, but immediately enters the conversion material 712 and the converted light 514, having a different wavelength, is generated into the liquid. This converted light 514 then hits the reflection material 710 and is reflected back as light 516 to the liquid 506. The lights 514 and 516 have the same wavelengths. The reflection material 710 is disposed in this embodiment outside the housing 502, so that a layer of air 720 is present in the annulus 722 formed with the housing. In such configuration, the up/down conversion material determines the emission of the light that the liquid containing compartment is exposed to (all light generated is essentially absorbed by the conversion element and re-emitted at the desired wavelength range).

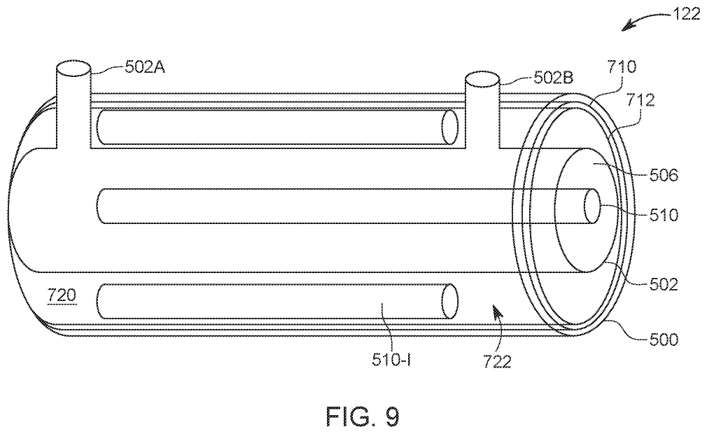

The reactor 122 may also be configured to have an additional light source 510-I, for example, distributed in the annulus 722, as shown in FIG. 9. In this implementation, the housing 502, which is transparent to the light generated by the light source 510, is placed inside a body 500, for example, steel or plastic. The reflector layer 710 is coating the interior wall of the body 500 and the conversion material 712 is placed inside the annulus 722 of the reflector layer 710 and the housing 502. Note that the conversion material 712 is removable placed inside the bore of the reflector layer 710. Additional light sources 510-I are placed in the annulus 722, around the central light source 510. Because the housing 502 is transparent, the light from the additional light sources 510-I enters the liquid 506 and then enters the conversion material 712 for changing its wavelength. Next, the lights are reflected from the reflection material 710 and enter again the liquid 506. In this embodiment, the value of I may be one or more. FIG. 9 also shows the housing 502 having an inlet 502A and an outlet 502B for receiving the contaminated liquid and discharging the purified liquid, respectively. The other elements of the FLT system 100 are omitted in this figure for simplicity.

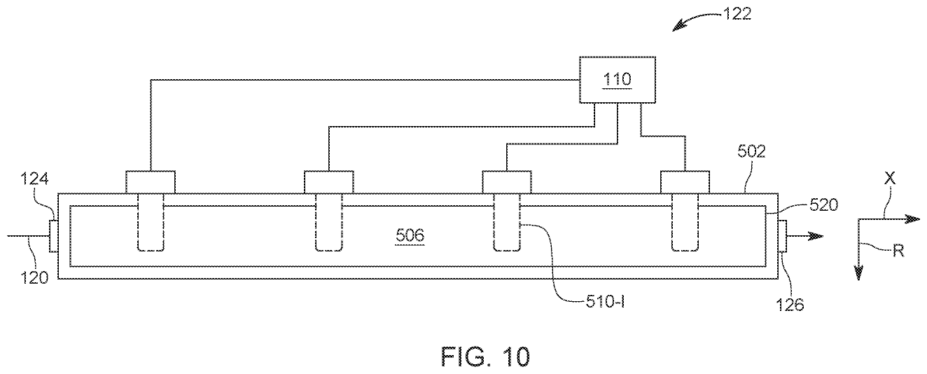

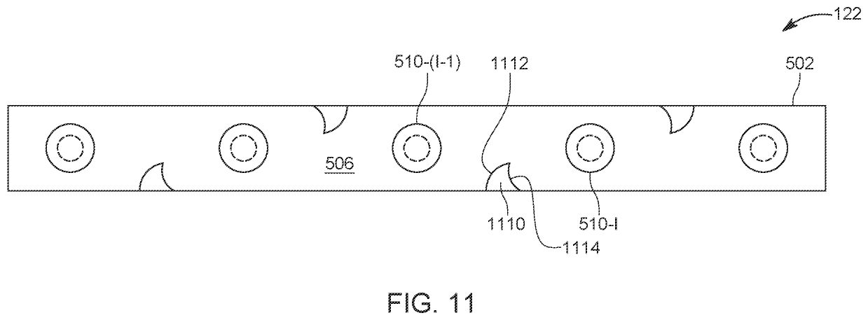

FIG. 10 shows another implementation of the reactor 122 in which plural light sources 510-I are entering through a side wall of the housing 502. The plural light sources 510-I are distributed along a longitudinal direction X of the reactor. The light sources extend along a radial direction R of the reactor, while in the previous embodiments the light sources extended along the longitudinal direction X of the reactor. The coating layer 520 is present around the interior surface of the housing 502 and the liquid 506 flows along the longitudinal direction X. In yet another embodiment, as illustrated in FIG. 11, the reactor 122 may be provided with one or more static mixers 1110, which are configured to mix the liquid 506, especially if a chemical is released from the storage tank 128 shown in FIG. 1. The static mixer 1110 is an obstacle formed on the inside surface of the housing 502. The static mixer 1110 may be shaped to have a convex surface 1112 facing a first light source 510-(1-1) and a concave surface 1114 facing a second light source 510-I, adjacent to the first light source, as illustrated in FIG. 11. In this way, the light emitted by the source lights is further dispersed through the housing 502 due to the mixers. In one application, these surfaces 1112 and 1114 may be switched. Other surface shapes may be used. In yet another application, that may be combined with any of the embodiments discussed herein, the surfaces 1112 and 1114 may be coated with one or both of the reflector material 710 and the conversion material 712, to also change the wavelength of the reflected light.

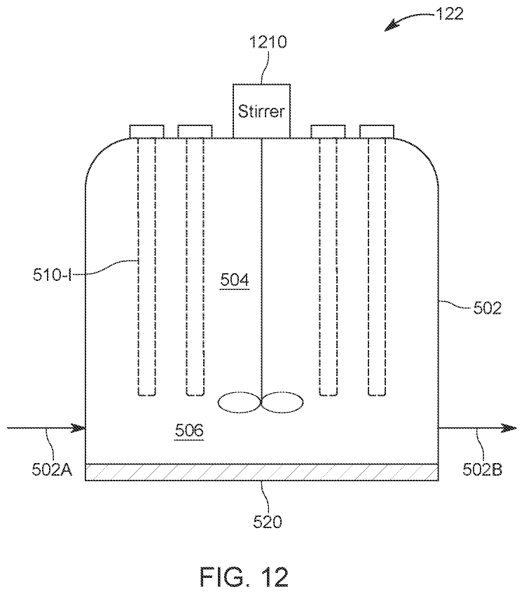

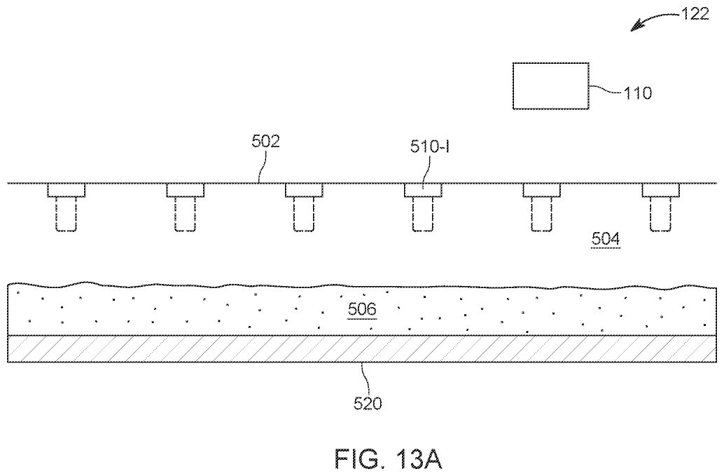

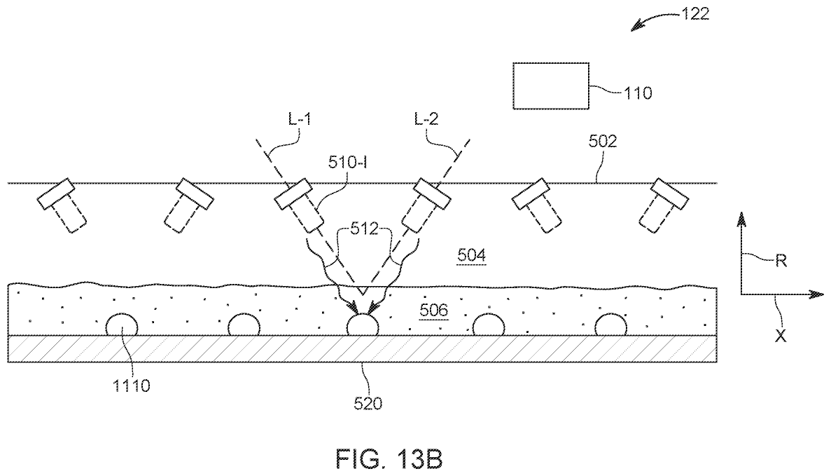

FIG. 12 shows yet another implementation of the reactor 122, where the coating layer 520 is distributed at the bottom of the chamber 504 holding the liquid 506. Plural lamps 510-I extend into the chamber 504, parallel to each other. A stirrer mechanism 1210, which may be the passive mechanism 1110 shown in FIG. 11 or an active one (e.g., a motor that turns a small propeller, or an air stirrer) that also extends into the chamber, parallel to the lamps 510-1. FIGS. 13A and 13B show further variations of the reactor 122. FIG. 13A shows plural light sources 510-I extending into the chamber 504, formed by the housing 502, and the coating layer 520 is provided opposite to the light sources, only on a portion of the inner wall of the housing 502. The liquid 506 in this embodiment does not fill the chamber 504, different from the embodiments shown in FIGS. 5A to 12. In fact, in this embodiment, no light source 510-I is in direct contact with the liquid 506. This feature may be implemented in any of the above embodiments.

The embodiment illustrated in FIG. 13B is similar to that shown in FIG. 13A except that the plural lights 510-I are making a non-zero angle with the radial direction R (note that in FIG. 13A, the light sources extend along the radial direction R), and one or more mixers or reflectors 1110 are provide above the coating layer 520, inside the chamber 504, to directly interact with the liquid 506. One or more of the reflectors 1110 may also include a conversion material 712. The reflectors 1110 may be placed at an intersection of two longitudinal axes L1 and L2 and beams 512 emitted by two adjacent light sources, as illustrated in the figure. In other words, the light sources 510-I are not only oriented in this embodiment to make a non-zero angle with the radial direction R, but their orientation is coordinated to be aligned with the reflectors/mixers 1110, which are located opposite to the light sources, inside the chamber 504. In this embodiment, the amount of liquid 506 is controlled to not reach the light sources. However, one skilled in the art would understand that it is possible to increase the amount of liquid 506 to fill the chamber 504.

The controller 110, which is configured to control all the light sources, may be programmed for the embodiments shown in FIGS. 10, 11, 13A and 13B to activate in a certain sequence the light sources, i.e., depending on the measured liquid flow through the reactor, each light source is activated when the same volume of liquid passes in front of it. In other words, for any given of liquid, the controller 110 sequentially activates the light sources so that the given volume of liquid is first irradiated by the first light source, then by the second light source, and so on. Thus, the same volume of liquid is irradiated with the generated light multiple times, up to the number of light sources present in the reactor. In this way the efficiency of removing the pollutants increases as the same volume of liquid is irradiated multiple time. The controller 110 may also be configured to trigger the light sources to irradiate each time the same given volume of liquid with another light spectrum, to address plural types of contaminants, i.e., virus and bacteria, organic matter, pesticides, phenols, textile dyes, etc.

Equally applicable to all the embodiments discussed above, for direct photolysis (i.e., no oxidant addition, just FLT treatment), the overall degradation rate constant increases with a decrease in the path length between the light source and the pollutant. Polychromatic light sources will be more sensitive to the path length than monochromatic ones (254 nm). The light path length is strongly affected by the water quality, where turbidity and contaminants concentration play a key role.

In the case of oxidant addition (indirect photolysis), the optical path is affected by the oxidant dose, where for a low-dose of oxidant, the degradation might increase by increasing the optical path. For example, at low oxidant doses, the degradation constant increased by 160% when the optical path was increased from 2 to 30 cm. Therefore, to ensure a certain efficiency, the optical path is selected based on the knowledge that the optical path depends on the type of the treatment, the water quality, and the use of oxidants. A shorter optical path is preferable for polluted water and directed photolysis. In one embodiment, a length of the optical path for the implementations discussed above is in the range of 0.1 cm to 50 (or 100) cm. Other values may be selected depending on the type of pollutants, the available light spectrum, and the desired speed of the liquid stream through the reactor.

The efficiency of the FLT treatments for various OMPs for the systems discussed above has been tested as now discussed. The selection of OMPs was based on their environmental relevance. Individual stock solutions of acetaminophen, diclofenac, gemfibrozil, ibuprofen, ketoprofen, mefenamic acid, carbamazepine, primidone, estrone, 17a-ethiny estradiol, bisphenol-a, naproxen, and triclosan were prepared in methanol at a concentration of 1 g L⁻¹. The eleven selected OMPs consist of analgesic and anti-inflammatories, antibacterial, lipid regulators, estrogen, hormones, and plasticizers. A cocktail of OMPs was further prepared with those individual solutions at a concentration of 10 mg L⁻¹. This cocktail was added to DI water to achieve a target concentration of 500 μg L⁻¹, which was employed as the initial solution for the FLT treatment. The concentration of the selected contaminants on this initial solution was about 100-fold greater than the concentrations reported in actual wastewater effluents.

None of the samples treated contained hydrogen peroxide or any other photocatalyst in order to examine the sole contribution of the FLT treatment on photodegradation of the different OMPs. Once prepared, the solution was inserted in a sealed-quartz tube (body 502, which is fully transparent in the wavelength range of 200-1000 nm) and placed in closed proximity to a Xenon flash lamp 510-I, which has the spectrum shown in FIG. 6. To minimize unwanted temperature fluctuations in the sample due to FLT, the quartz tube 502 containing the solution 506 was maintained close to room temperature using an air-based cooling system. The effects of the optical pulse length, number of pulses (1, 5, 10, 15, and 20) and energy intensity (2, 5 and 10 J/cm²) applied by the lamp 510-I on the various OMPs were then systematically studied. Each light pulse for this study had a duration of 2 ms and a frequency of 0.2 s⁻¹. Sample treatments involving more than 5 pulses were carried out in cycles of 5 pulses with one cycle every 2 min in order to maintain a constant temperature across the sample. The energy intensity of each optical pulse was controlled by adjusting the applied voltage across the xenon lamp 510-I.

The concentrations of OMPs were determined using Gas Chromatography Mass Spectrometry technique (GC-MS). In brief, 100 μL processed-solutions were evaporated under a nitrogen stream. Once reaching complete dryness, the samples were reconstituted and derivatized in 50 μL of N, o-bis(trimethylsilyl) trifluoroacetamide (BSTFA) and 50 μL of pyridine, vortexed together for 30 s at 3200 rpm and placed in an oven for 20 min at 70° C. The generated solutions were cooled and then injected in a gas chromatograph system coupled with a high vacuum pump with a triple-axis detector. Chromatographic separation was performed with a polymer with 0.25 μm pore size (60 m×0.25 mm). The injection volume was 1 μL in splitless mode, pressure 20.093 PSI, and oven temperature program as follows: 80° C. for 1 min, ramping up from 80 to 260° C. from minute 1 to 13 (15° C. min⁻¹), then from 260 to 300° C. from minute 13 to 22 (at 4.4° C. min⁻¹) and holding at 300° C. until minute 30. Helium was used as carrier gas at a constant flow of 0.8 mL min⁻¹.

The FLT technique with the system discussed above was used to irradiate the OMP samples with high-intensity light pulses. FIG. 6 shows the light emission spectra of the Xenon flash lamp 510-I used at different voltage inputs (i.e., different energy intensities). The emission spectrum of the flash light presents a broad spectrum of 200-1000 nm with a mean power intensity in the visible range (˜480 nm). Along with the high intensity in the visible range, the emission spectrum also contains significant amounts of optical energy in the ranges of UV-A (315-400 nm), UV-B (280-315 nm), and UV-C(200-280 nm), which may be beneficial for the treatment of water. The wavelength range of 200-280 nm possess enough energy to excite electrons from a bonding 1T orbital to an antibonding π* orbital (π→π* transitions) within organic conjugated 1T systems and a variety of other functional groups, upon illumination, thus promoting the organic compounds degradation. Thus, the FLT system 100 combines fast processing times with precise control over the various processing parameters and can thus induce photolysis and photochemical reactions in organic materials present in aqueous solutions (AOS).

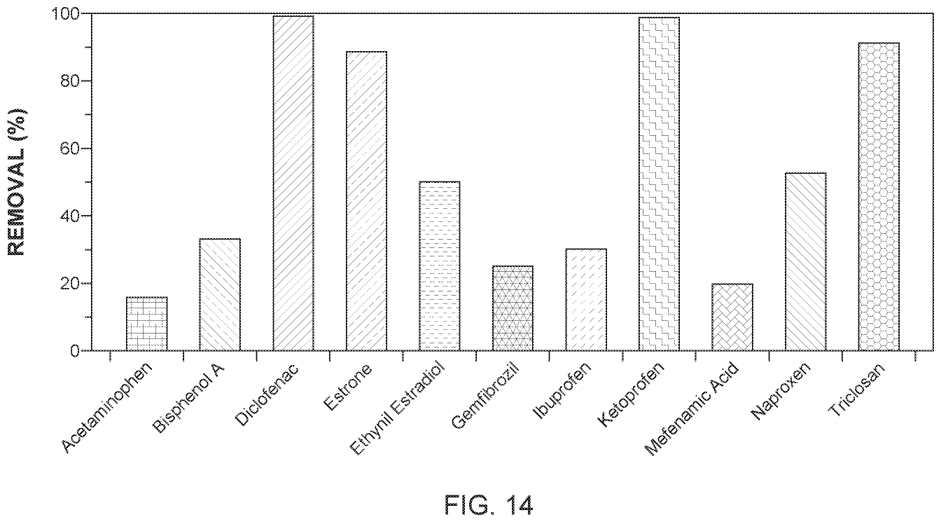

FIG. 14 shows the removal percentage (%) for each of the 11 compounds tested after treatment with a single pulse (2 ms) of white light produced using a power intensity of 10 J/cm² (applied voltage of 551 V). As evident from the data in FIG. 14, different degrees of removal, ranging from 16% to 99%, were observed among the 11 OMPs. Ketoprofen, Diclofenac, Triclosan, and Estrone showed the highest photodegradation after a single light pulse treatment with corresponding removal percentages of 99, 99, 91, and 88%, respectively.

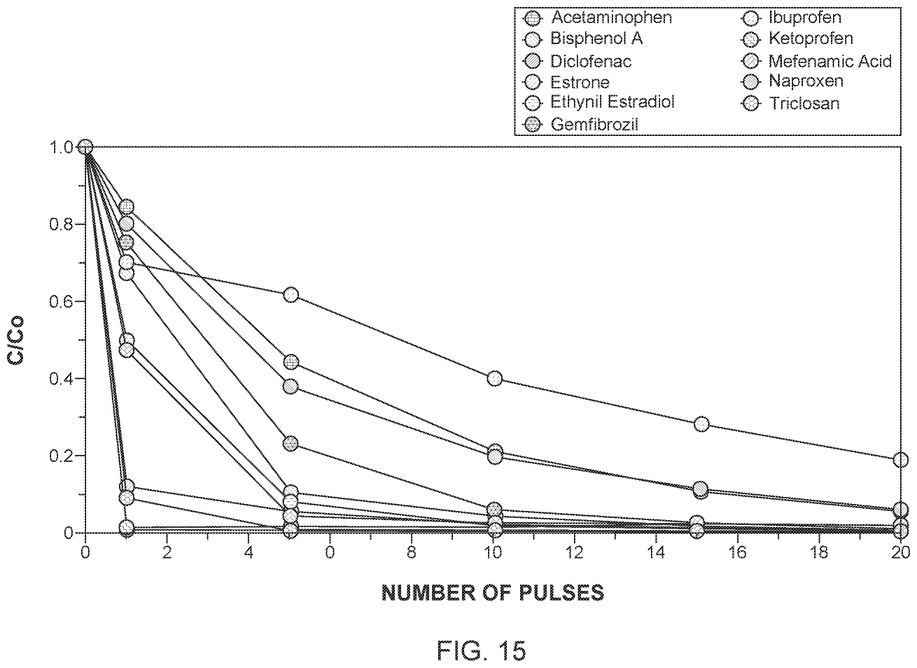

The removal efficiency increased when increasing the number of pulses, as highlighted by the decrease of the concentration of the OMPs illustrated in FIG. 15. More specifically, upon application of 10 high light intensity pulses (10 J/cm²), which corresponds to an overall irradiation time of 20 ms, a removal efficiency of larger than 90% was measured for 8 of the 11 OMPs. As expected, increasing the total irradiation time led to increased concentrations of radical species in the solution due to the decomposition of the OMPs to lower molecular weight compounds.

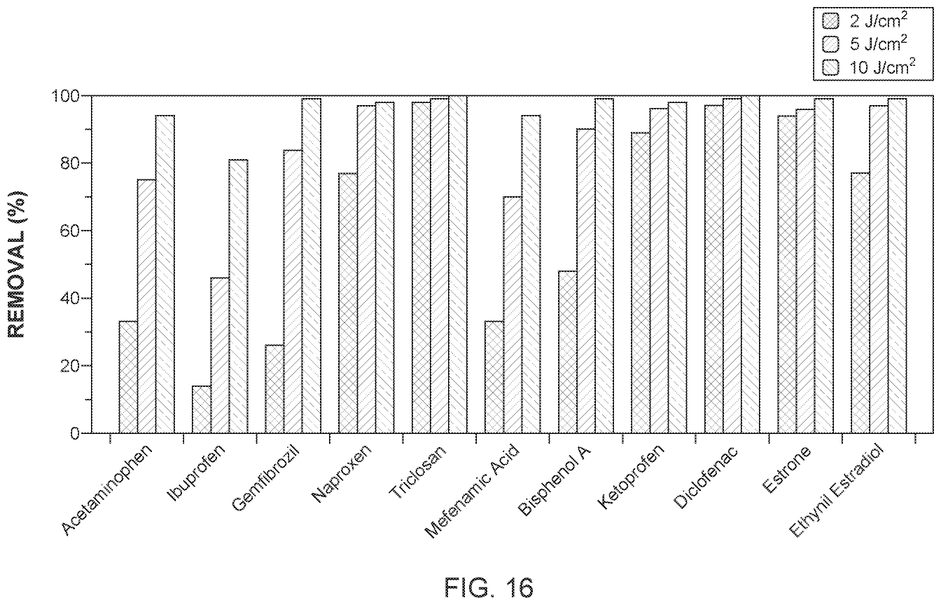

As already discussed, the FLT system tested here allows for the precise control of key processing parameters including the duration and energy intensity of the applied light pulse. The latter parameter allowed to study the effect of different light pulse intensities on the treatment efficiency. FIG. 16 shows the removal efficiency for the 11 OMPs studied after treatment with 20 light pulses (overall irradiation time of 40 ms) at three different light energy intensities (i.e., 2, 5 and 10 J/cm²). By increasing the energy intensity of the light pulses, it leads to higher removal efficiency for all OMPs studied, with most values approaching 100%, as illustrated by FIG. 16. This is believed to be due to the increased degradation rate attributed to the formation of more reactive species in the solution. The results are in agreement with the effect of increasing the number of pulses shown in FIG. 15, thus highlighting that photodegradation of the organic compounds is directly linked to the optical energy supplied to the sample.

Treating the samples with 20 light pulses (10 J/cm²) was found to remove more than 99% of all the targeted OMPs except Acetaminophen, Mefenamic Acid, and Ibuprofen, for which the overall removal efficiency was 94%, 94% and 81%, respectively. These compounds have been previously reported to be resistant to photodegradation, requiring extended UV irradiation for partial removal from an aqueous solution. Liu et al. achieved 75% removal of Acetaminophen after 120 min of treatment with simulated sunlight irradiation. Iovine et al. observed the removal of Ibuprofen from water up to 75% after 60 min of UV treatment. Ibuprofen, at concentration of 60 mg L⁻¹, was removed with an efficiency of 91.7% after 80 min of non-thermal plasma with wetted-wall corona discharge. Removals up to 72% with 200 min of UV irradiation were reported for Mefenamic Acid. For photon-based treatment techniques, the efficiency of photodegradation heavily depends on the molecular structure of the OMP. In this regard, it is well established that the photostability of a given compound depends on its optical absorption characteristics and the quantum yield. When compared with the treatment times reported for other techniques, the time(s) required for the removal/photodegradation of OMPs by the current FLT method are significantly shorter, for example, in the order of milliseconds. This feature highlights the advantage of the FLT system 100 for high throughput applications.

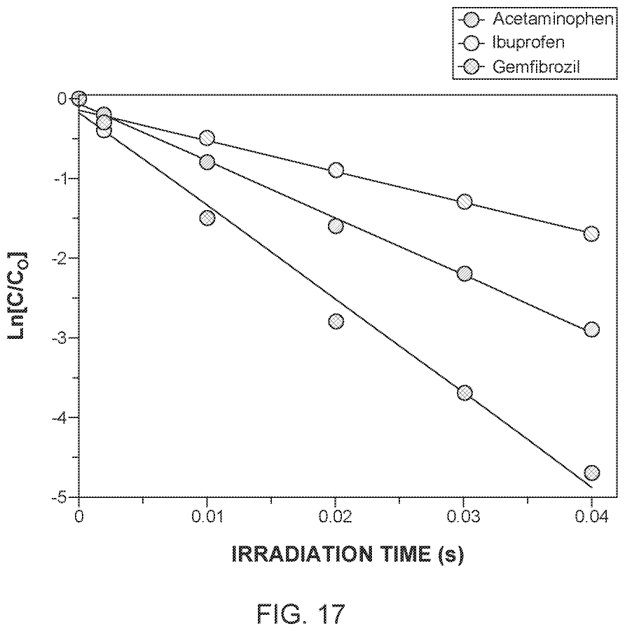

The inventors further analyzed the kinetics associated with the FLT treatment. The obtained results indicate that a degradation of the targeted micropollutants in water with the FLT system 100 follows a first-order kinetic, which can be described using the following equation:

$$\\ \begin{matrix}ln [ \frac{C}{{C}_{0}} ] = - {K}^{′} \cdot t & ( 1 )\end{matrix}$$

where C₀ is the initial concentration of the OMP, C is the concentration of the OMP at a selected time, and K′ is the apparent reaction rate constant. The concentrations of 3 OMPs versus total irradiation time are presented in FIG. 17, and they show a linear decrease of the logarithmic relative residual concentration

$$\\ ln [ \frac{C}{{C}_{0}} ]$$

with an increase in the treatment time. A similar trend is observed for all OMPs studied. Such first order kinetics is in agreement with previous studies on the degradation of pharmaceuticals in water using aqueous organic pollutants.

The inventors have further observed that the kinetics of photodegradation can be affected by several parameters, including the irradiation time and the intensity of the light. Experiments were performed for measuring the relative residual concentration of Acetaminophen, Gemfibrozil, Ibuprofen, and Mefenamic Acid versus the number of pulses at three different light intensities. The results confirmed that the removal efficiency is directly affected by the light intensity of the used pulses. The results indicated that by increasing the energy, the rate of degradation increased while the reaction order (first-order kinetics) remains constant.

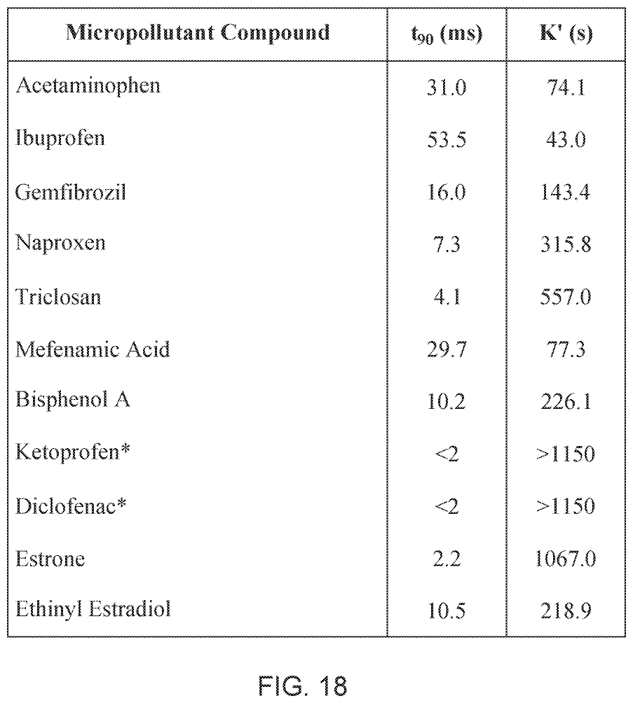

The table in FIG. 18 summarizes the time required for a 90% removal (t₉₀) and the apparent rate constants (K) following FLT treatment using the highest light energy density (10 J/cm²) at 500 μg L⁻¹ of OMP concentration. The apparent kinetic rate constants of the treated OMPs ranged from 43 s to up more than 1500 s. The results reported in the table may be used in the decision-making process illustrated in FIGS. 3 and 4 for determining the treatment settings 130 to be applied to the reactors. The OMPs studied required irradiation from 2 to 55 ms to be reduced to a tenth of their initial concentration (i.e., less than 50 μg L⁻¹). Ketoprofen and Diclofenac exhibit a K′ value larger than 1150 s since their removal efficiency exceeded 90% upon treatment with a single light pulse (2 ms). On the basis of these results, it can be concluded that the FLT system 100 can be efficiently used for the rapid degradation of OMPs in flowing aqueous solutions, exhibiting t₉₀ values in the ms range for initial OMPs concentration of 500 μg L⁻¹.

The order of degradation obtained for the various OMP compounds here followed a similar trend to that reported previously for various other micropollutants. For example, studied the photodegradation of various pharmaceuticals and estrogens in MilliQ water using a Xenon arc lamp. They reported the following order of degradation: Ketoprofen>Naproxen>Estrone>Ethinyl>Estradiol>Gemfibrozil>Ibuprofen, with half-live (t_{1/2}) of 0.4, 1.9, 4.7, 28.4, 91 and 208 h, respectively. The rate of degradation of the same OMPs subjected to the FLT system at 10 J/cm² presented the following order of degradation; Ketoprofen>Estrone>Naproxen>Ethinyl Estradiol>Gemfibrozil>Ibuprofen with t₉₀ of <2, 2, 7, 10, 16 and 53 ms, respectively. These results suggest that the photodegradation mechanism remains similar and the significant difference in degradation rates is attributed to the unique ability of the FLT system to supply high optical energy in a short time.

The relative residual concentration of OMPs normalized to their initial concentration c/c₀ as a function of the number of pulses at three different optical energy densities for 4 of the OMPs have also been studied by the inventors. A correlation between c/c₀ and the energy density was observed, suggesting that the degradation of OMPs in water using the FLT system 100 correlates to the optical power and number of pulses. Thus, it is possible to evaluate the amount of energy necessary to achieve the desired degradation for each OMP.

An advantage of the FLT technology discussed herein with respect to AOPs is the unprecedented fast (milliseconds) degradation rates achieved, see, for example, the table in FIG. 18. However, the FLT technology combines additional advantages over other treatment techniques, such as plasma and sonolysis, both in terms of setup design as well as degradation kinetics. Specifically, established AOPs require irradiation times in the range of minutes to hours in order to degrade OMPs present in aqueous solutions. The latter requirement leads to long hydraulic retention time, which in turn limits the overall throughput of the process while increasing the cost. To this extent, the removal rate is a parameter desired to be minimized for the design of efficient reactors, which can in turn determine the scalability of the technology. The ability of the FLT system 100 to combine ultra-fast removal rates for a gamut of OMPs in water, using a simple and highly scalable system design, makes the proposed method one of the most promising approaches reported to date. Furthermore, the fast degradation kinetics enables the reactors discussed herein to operate in a continuous flow mode, allowing the treatment of liquid streams in water and wastewater treatment industries.

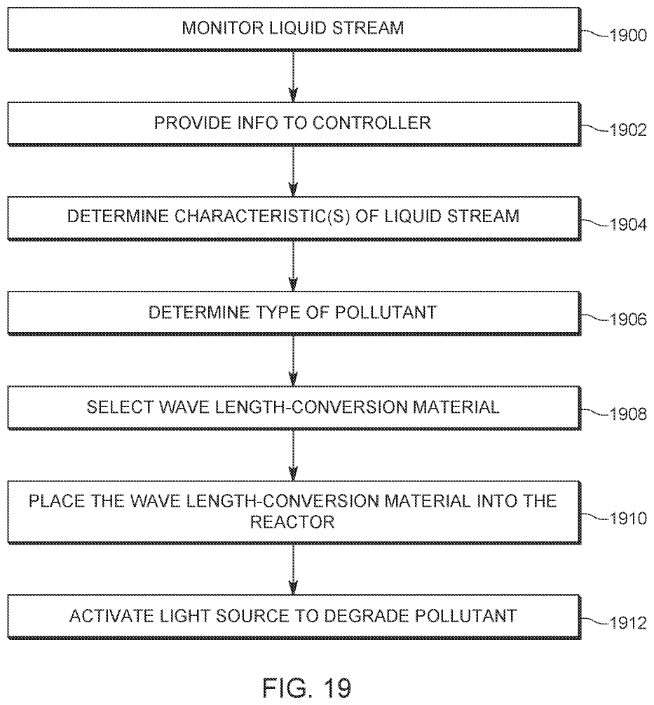

A method for removing one or more OMP from a flowing liquid stream (e.g., contaminated water) is now discussed with regard to FIG. 19. The method includes a step 1900 of monitoring the liquid stream as it enters into the reactor 122. This step may be performed with the sensor 124 discussed above. Information from the sensor 124 is provided to the controller 110 in step 1902. The controller 110 determines in step 1904 one or more characteristics of the liquid stream, for example, temperature, pH, electrical conductivity, turbidity, associated absorption spectrum, density, type of organic material, etc., depending on the type of sensor used. Note that sensor 124 may include in fact plural sensors, one for each of the characteristics mentioned above. Further, the controller 110 together with the database 134 and the Al algorithm 132 shown in FIG. 4 determine in step 1906, based on the readings from the sensor 124 (e.g., absorption spectrum) and the speed of the liquid stream through the reactor 122, what kind of organic pollutants are present, and what irradiation regimen needs to be applied. The irradiation regimen includes the wavelength spectrum to be applied, the intensity of the light generated by the light source 510, the duration of the flash generated by the lights source 510, and/or the frequency of the applied pulses. Based on this determination, an appropriate wavelength-conversion material 712 is selected in step 1908, i.e., a wavelength-conversion material that generates the required wavelength spectrum for that specific organic pollutant. Note that the naturally generated wavelength spectrum of the light source 510 may be different from the required wavelength spectrum for degrading the specific organic pollutants. The selected wavelength-conversion material 712 bridges this gap, by transforming the natural wavelength spectrum of the light source to the required wavelength spectrum.

In step 1910, the selected wavelength-conversion material 712 is placed in the reactor. Note that if plural reactors are used, then this step is applicable to each reactor and the wavelength-conversion material 712 may be the same for all the reactors, or individually selected for each reactor. If the latter situation is true, the controller 110 is configured to choose the material 712 so that each reactor degrades a corresponding organic pollutant. This means that in one application, two different reactors are configured to degrade two different organic pollutants. In other words, if plural reactors are present, the controller choses one wavelength-conversion material per organic pollutant so that the conversion material achieves maximum degradation of that pollutant. If only one reactor is available, then the controller selects a wavelength-conversion material that degrades all the pollutants. In step 1912, the controller 110 activates the light source 510 to generate the desired wavelength spectrum to degrade the pollutant(s). This step implements the characteristics or regimen discussed in step 1906.

The method may also include a step of selecting the amount of energy to be generated by the light source, the pulsing frequency of the light source, the duration of each light pulse, the sequence in which the various light sources in the same reactor or plural reactors are activated, etc., i.e., the regimen. In yet another step, it is possible to determine that addition of an oxidant is required and thus, the controller instructs the storage tank 128 discussed with regard to FIG. 1 to release a certain amount of oxidant into the incoming liquid stream to boost the organic material degradation. In still another step, the controller 110 receives readings from the downstream sensor 126 and evaluates the amount of the organic pollutant not degraded by the first reactor. This value is then used to determine the wavelength-conversion material for the next reactor, and/or the amount of energy, the duration of the pulse, the frequency of the pulse for the next reactor, or to adjust the conversion material of the current reactor, or to adjust the regimen of the current reactor. In other words, the readings from the next sensor are used to adjust the output of the light source for the next reactor or the current reactor or both. In a different embodiment or in combination with any of the above discussed embodiments, the readings from the downstream sensor may be used to adjust the output of the light source of the previous reactor, i.e., if the estimations determined based on the upstream sensor 124 are not good enough to degrade the organic pollutant, the readings from the downstream sensor 126 are used to adjust the output of the light source.

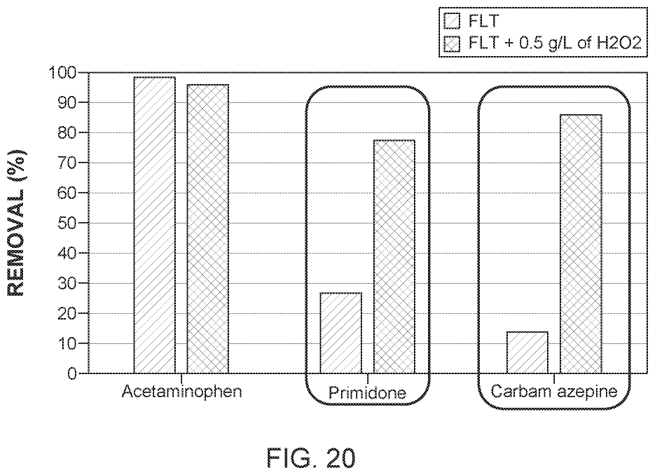

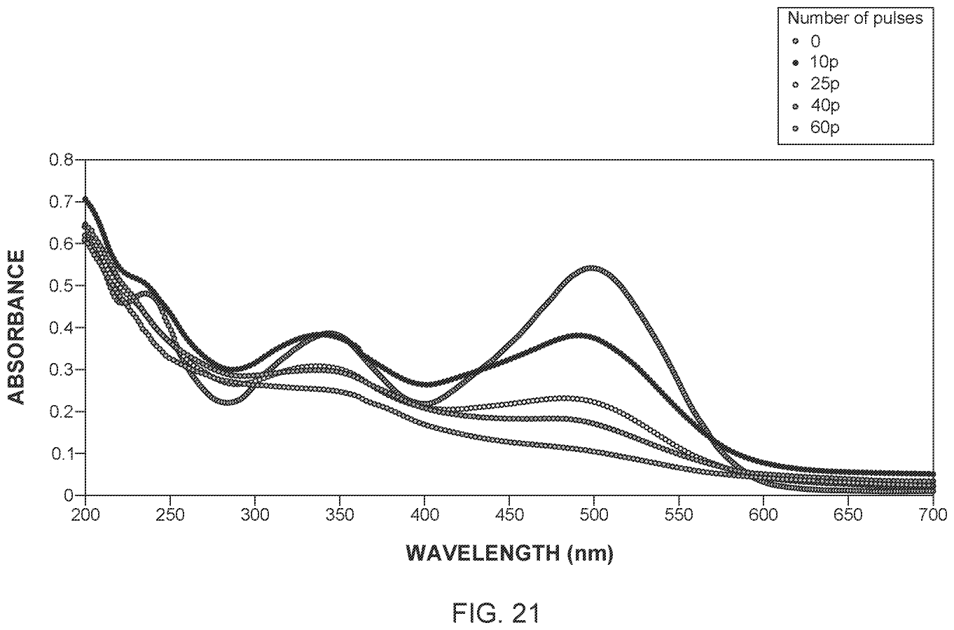

This method has been tested by the inventors to remove various organic pollutants from a water stream with and without adding an oxidant. FIG. 20 shows the obtained results for three different organic pollutants in the presence and absence of the H₂O₂. It is noted that the added oxidant increased the degradation efficiency of the organic material resistant to pure photolysis. The method has also been applied to degrading the Congo red pollutant from water, which is typically found in textile dye treatment facilities. FIG. 21 shows the absorbance versus the wavelength for Congo red dye concentration of about 20 mg/L versus wavelength, for different numbers of pulses. The decrease in absorbance around 496 nm indicates the efficiency of the treatment.

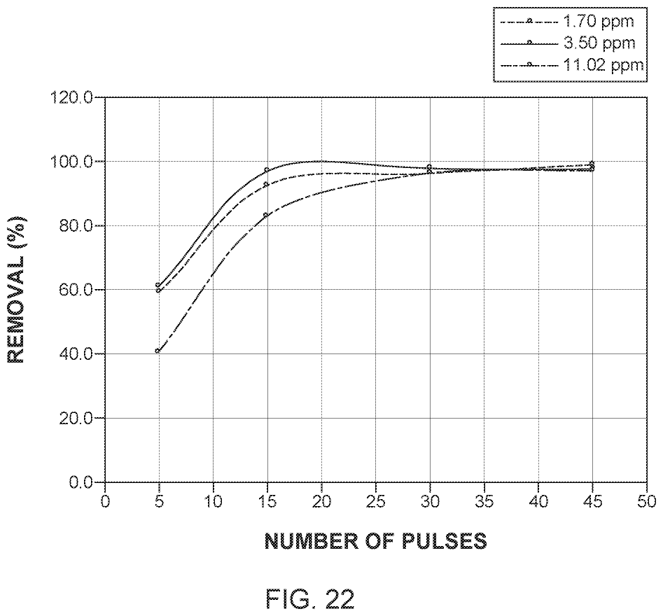

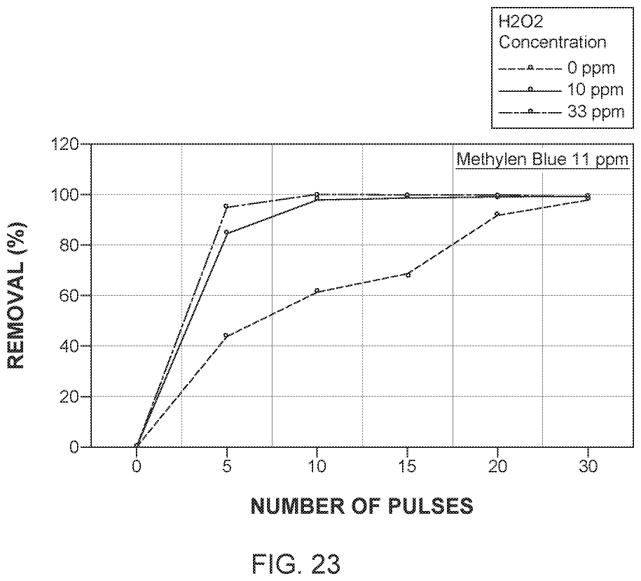

FIG. 22 shows the degradation of methylene blue (MB) in the textile dye treatment as the percentage of removal versus the number of pulses at different concentrations of the MB in water. This graph demonstrates that the treatment parameters/conditions may vary depending on the sample under treatment. This is interesting as the process conditions in an ideal system can be tailored accordingly. This could be implemented via an integrated inline monitoring system that assess the water at the input and adjusts the treatment process in an optimal manner, as discussed with regard to the method of FIG. 19. This may involve intermittent monitoring of the treatment process using, for example, additional monitoring stages and a modular treatment set up (i.e., a system that consists of more than one lamp/treatment reactors stages). Using AL algorithms 132 with the controller 110, the system 100 may be further optimized by implementing appropriate training algorithms making it more efficient and fast. Such approaches are known to those skilled in the art of Al-based systems. When the controller 110 decides to add an oxidant to accelerate the degradation/removal process, the total removal of the pollutant is much faster achieved, as illustrated in FIG. 23.

The disclosed embodiments provide an active flash-light treatment system that is capable to determine what wavelength spectrum to apply to degrade existing organic pollutants. It should be understood that this description is not intended to limit the invention. On the contrary, the embodiments are intended to cover alternatives, modifications and equivalents, which are included in the spirit and scope of the invention as defined by the appended claims. Further, in the detailed description of the embodiments, numerous specific details are set forth in order to provide a comprehensive understanding of the claimed invention. However, one skilled in the art would understand that various embodiments may be practiced without such specific details.

Although the features and elements of the present embodiments are described in the embodiments in particular combinations, each feature or element can be used alone without the other features and elements of the embodiments or in various combinations with or without other features and elements disclosed herein.

This written description uses examples of the subject matter disclosed to enable any person skilled in the art to practice the same, including making and using any devices or systems and performing any incorporated methods. The patentable scope of the subject matter is defined by the claims, and may include other examples that occur to those skilled in the art. Such other examples are intended to be within the scope of the claims.

### REFERENCES

The entire content of all the publications listed herein is incorporated by reference in this patent application.
[1] Bruggeman, P.; Schram, D.; Gonzalez, M. A.; Rego, R.; Kong, M. G.; Leys, C., Characterization of a direct dc-excited discharge in water by optical emission spectroscopy. Plasma Sources Sci Technol. 2009, 18 (2), 25017.
[2] Giannakis, S.; Gamarra Vives, F. A.; Grandjean, D.; Magnet, A.; De Alencastro, L. F.; Pulgarin, C., Effect of advanced oxidation processes on the micropollutants and the effluent organic matter contained in municipal wastewater previously treated by three different secondary methods. Water Res. 2015, 84, 295-306.
[3] Bretos, I.; Jimenez, R.; Ricote, J.; Calzada, M. L., Photochemistry 320 in the low-temperature processing of metal oxide thin films by solution methods. Chem. —A Eur. J. 2020, chem.202000244.
[4] Skorupa, W.; Schumann, T.; Rebohle, L., Millisecond thermal processing using flash lamps for the advancement of thin layers and functional coatings. Surf. Coatings Technol. 2017, 314, 169-176.
[5] Voelskow, M.; Yankov, R. A.; Skorupa, W., Subsecond Annealing of Advanced Materials; 2014; Vol. 192.
[6] Druffel, T.; Dharmadasa, R.; Lavery, B. W.; Ankireddy, K., Intense pulsed light processing for photovoltaic manufacturing. Sol Energy Mater. Sol Cells 2018, 174 (May 2017), 359-369.
[7] Yarali, E.; Koutsiaki, C.; Faber, H.; Tetzner, K.; Yengel, E.; Patsalas, P.; Kalfagiannis, N.; Koutsogeorgis, D. C.; Anthopoulos, T. D., Recent Progress in Photonic Processing of Metal-Oxide Transistors. Adv. Funct. Mater. 2019, 1906022.
[8] Li, W.; Yarali, E.; Bakytbekov, A.; Anthopoulos, T. D.; Shamim, A., Highly transparent and conductive electrodes enabled by scalable printing-and-sintering of silver nanowires. Nanotechnology 2020, 31 (39), 395201.
[9] Yarali, E.; Faber, H.; Yengel, E.; Seitkhan, A.; Loganathan, K.; Harrison, G. T.; Adilbekova, B.; Lin, Y.; Ma, C.; Firdaus, Y.; et al., Low-Voltage Heterojunction Metal Oxide Transistors via Rapid Photonic Processing. Adv. Electron. Mater. 2020, 6 (6), 1-9.
[10] Nugraha, M. I.; Yarali, E.; Firdaus, Y.; Lin, Y.; EI-Labban, A.; Gedda, M.; Lidorikis, E.; Yengel, E.; Faber, H.; Anthopoulos, T. D., Rapid Photonic Processing of High-Electron-Mobility PbS Colloidal Quantum Dot Transistors. ACS Appl. Mater. Interfaces 2020, 12 (28), 31591-31600.
[11] Lin, A. Y.-C.; Reinhard, M., Photodegradation of common environmental pharmaceuticals and estrogens in river water. Environ. Toxicol Chem. 2005, 24 (6), 1303-1309.

1. An active flash-light treatment system configured to degrade organic pollutants in a liquid stream the system comprising:
a reactor configured to receive the liquid stream a light source configured to generate an emitted light having a first wavelength range;
an upstream sensor configured to measure a characteristic of the liquid stream before entering the reactor; and
a controller configured to analyze the characteristic of the liquid stream and to select a wavelength-conversion material for the reactor, based on the characteristic of the liquid stream,
wherein the wavelength-conversion material is configured to absorb the emitted light and generate a converted light having a second wavelength range, different from the first wavelength range, and
wherein the converted light irradiates the liquid stream to degrade the organic pollutants.

2. The system of claim 1, wherein the reactor has a housing that holds the liquid stream, and the wavelength-conversion material is placed outside the housing.

3. The system of claim 2, wherein the light source is placed within the housing, in direct contact with the liquid stream.

4. The system of claim 3, wherein the housing and the wavelength-conversion material form an annulus, and additional light sources are located in the annulus.

5. The system of claim 1, wherein the light source is a flash light.

6. The system of claim 1, wherein the characteristic is at least one of a type of the pollutant, a concentration of the pollutant, liquid stream turbidity, liquid stream flowrate, liquid stream temperature, liquid stream pH, liquid stream electrical conductivity, and absorption spectrum of the pollutant.

7. The system of claim 1, wherein the controller is configured to select the wavelength-conversion material based on the absorption spectrum of the pollutant and the liquid stream flowrate.

8. The system of claim 1, wherein the controller is further configured to select an energy of the emitted light, a length of a pulse of the light source, and a frequency of pulses emitted by the light source.

9. The system of claim 1, further comprising:
a downstream sensor configured to re-measure the characteristic of the liquid stream,
wherein the controller is configured to adjust at least one of an energy of the emitted light, a length of a pulse of the light source, and a frequency of pulses emitted by the light source based on the re-measured characteristic.

10. The system of claim 1, further comprising:
a reflective material located around the wavelength-conversion material, to reflect all light back to the liquid stream.

11. A reactor that is part of an active flash-light treatment system configured to degrade organic pollutants in a liquid stream the reactor comprising:
a housing configured to house the liquid stream while the liquid stream flows through the reactor;
a light source configured to generate an emitted light having a first wavelength range, wherein the light source is placed within the housings); and
a removable wavelength-conversion material configured to absorb the emitted light and generate a converted light having a second wavelength range, different from the first wavelength range,
wherein the converted light irradiates the liquid stream to degrade the organic pollutants.

12. The reactor of claim 11, further comprising:
a reflective material placed around the wavelength-conversion material to reflect light back to the liquid stream.

13. The reactor of claim 11, wherein the wavelength-conversion material forms an annulus with the housing, and the annulus is filled with air.

14. The reactor of claim 13, further comprising:
additional light sources placed in the annulus.

15. The reactor of claim 11, wherein the wavelength-conversion material is placed around the light source, within the housing.

16. The reactor of claim 11, further comprising:
static mixers attached to an internal wall of the housing, the static mixers being configured to mix the liquid stream.

17. The reactor of claim 16, wherein one surface of a static mixer is convex.

18. The reactor of claim 16, wherein at least one surface of a static mixer is coated with the wavelength-conversion material.

19. A method for degrading organic pollutants in a liquid stream with an active flash-light treatment system the method comprising:
monitoring a characteristic of the liquid stream entering a reactor with an upstream sensor;
determining the characteristic with a controller determining a type of the organic pollutant at the controller based on the characteristic;
selecting a wavelength-conversion material based on the characteristic of the liquid stream;
removably placing the wavelength-conversion material onto the reactor; and
emitting a light having a first wavelength range, with a light source which is located within the reactor, to degrade the organic pollutants,
wherein the wavelength-conversion material is configured to absorb the emitted light and generate a converted light having a second wavelength range, different from the first wavelength range, and
wherein the converted light irradiates the liquid stream to degrade the organic pollutants.

20. The method of claim 19, wherein the characteristic is at least one of a type of the pollutant, a concentration of the pollutant, liquid stream turbidity, liquid stream flowrate, liquid stream temperature, liquid stream pH, liquid stream electrical conductivity, and absorption spectrum of the pollutant,
wherein the controller is configured to select the wavelength-conversion material based on the absorption spectrum of the pollutant and the liquid stream flowrate, and
wherein the controller is further configured to select an energy of the emitted light, a length of a pulse of the light source, and a frequency of pulses emitted by the light source.

21. (canceled)
